(19) United States
(12) Patent Application Publication
(10) Pub. No.: US 2020/0247245 A1
(43) Pub. Date: Aug. 6, 2020

(54) ADAPTIVE POWERTRAIN CONTROL OF AN ELECTRIC VEHICLE

(71) Applicant: Proterra Inc., Burlingame, CA (US)

(72) Inventors: Seneca A. SCHEPMANN, Greenville, SC (US); Tyler J. ZELLMER, Simpsonville, SC (US)

(73) Assignee: Proterra Inc., Burlingame, CA (US)

(21) Appl. No.: 16/781,400

(22) Filed: Feb. 4, 2020

Related U.S. Application Data
(60) Provisional application No. 62/801,718, filed on Feb. 6, 2019.

(51) Int. Cl. B60L 15/20

(52) U.S. Cl. CPC B60L 15/20; B60L 2240/423; B60G 11/27; B60L 2200/18; B60L 2240/26; B60L 2250/28

(57) ABSTRACT

An electric vehicle may include an electric motor, a suspension system, an inverter configured to control the electric motor based on an inverter signal, and a control system. The control system may be configured to receive data indicative a desired torque and data from the suspension system, and determine the inverter signal based on (a) the operator input data and (b) the data from the suspension system, and direct the determined inverter signal to the inverter.

### CROSS-REFERENCE TO RELATED APPLICATIONS

This application claims the benefit of U.S. Provisional Application No. 62/801,718, filed Feb. 6, 2019, the disclosure of which is incorporated herein by reference in its entirety.

### TECHNICAL FIELD

Embodiments of this disclosure relate to methods and systems for adaptive control of the powertrain of an electric vehicle.

### BACKGROUND

In an electric vehicle, or a hybrid vehicle operating in the electric mode, an electric motor serves as the source of power for the vehicle. In such vehicles, a battery provides power to drive the motor and a controller controls the operation of the motor. When the driver of the vehicle presses down on the accelerator pedal, the controller detects the position of this pedal and sends a signal to the motor to change its speed. The controller utilizes the input from the accelerator pedal as an intent from the driver to generate torque. The controller will typically include an algorithm to correlate (or map) the accelerator pedal position to the demanded torque. Some more advanced control schemes will modify this mapping based on the selected “drive mode” of the vehicle. For example, when the vehicle is in an economy mode (or “Eco” mode), the controller may decrease the “torque demand” for a given accelerator input. The current disclosure discloses systems and methods for adaptively controlling the vehicle torque based on data from the suspension system of the vehicle.

### SUMMARY

Embodiments of the present disclosure relate to, among other things, systems and methods for controlling the motor of an electric vehicle, and electric vehicles that incorporate the control methodology. Each of the embodiments disclosed herein may include one or more of the features described in connection with any of the other disclosed embodiments.

In one embodiment, an electric vehicle is disclosed. The electric vehicle may include an electric motor configured to provide traction for the electric vehicle, a suspension system, an inverter operatively coupled to the electric motor and configured to control the electric motor based on an inverter signal, and a control system. The control system may be configured to receive operator input data indicative a desired torque, receive data from the suspension system, determine the inverter signal based on (a) the operator input data and (b) the data from the suspension system, and direct the determined inverter signal to the inverter.

In another embodiment, an electric vehicle is disclosed. The electric vehicle may include a powertrain configured to provide traction. The powertrain may include a power controller operatively coupled to an electric motor. The power controller may be configured to control the electric motor based on a received power signal. The electric vehicle may also include an accelerator pedal, and a suspension system. The suspension system may include (a) one or more air-springs and (b) one or more pressure sensors configured to detect a pressure in the one or more air-springs. The electric vehicle may also include a control system configured to receive data from the accelerator pedal, receive data from the one or more pressure sensors of the suspension system, and determine the power signal based on (i) the accelerator pedal data and (ii) the data from the one or more pressure sensors.

In yet another embodiment, a method of operating a vehicle is disclosed. The method includes receiving data indicative of a requested torque from an accelerator pedal of the vehicle, receiving data indicative of vehicle weight from a suspension system of the electric vehicle, and determining a torque request signal based on (a) the received accelerator pedal data and (b) the received data from the suspension system. The method may also include controlling a power source of the vehicle based on the determined torque request signal to produce torque.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 is an illustration of an exemplary electric vehicle;

FIG. 2 is a schematic illustration of an exemplary powertrain of the electric vehicle of FIG. 1;

FIG. 3 is a schematic illustration of a portion of an exemplary suspension of the electric vehicle of FIG. 1;

FIG. 4 is a schematic illustration of a portion of a control unit of the electric vehicle of FIG. 1;

FIGS. 5A-5C are simplified graphical illustrations of preprogrammed maps or curves in the control unit of FIG. 4 in an exemplary embodiment; and

FIG. 6 is a simplified flow chart that illustrates an exemplary method for adaptively controlling the powertrain of the electric vehicle of FIG. 1.

### DETAILED DESCRIPTION

Unless defined otherwise, all terms of art, notations and other scientific terms or terminology used herein have the same meaning as is commonly understood by one of ordinary skill in the art to which this disclosure belongs. All patents, applications, published applications and other publications referred to herein are incorporated by reference in their entirety. If a definition set forth in this disclosure is contrary to, or otherwise inconsistent with, a definition in these references, the definition set forth in this disclosure prevails over the definitions that are incorporated herein by reference. None of the references described or referenced herein is admitted to be prior art to the current disclosure.

The present disclosure describes systems and methods for adaptively controlling the powertrain of an electric vehicle. While principles of the current disclosure are described with reference to an electric bus, it should be understood that the disclosure is not limited thereto. Rather, the systems and methods of the present disclosure may be used in any electric or hybrid vehicle or machine. As used herein, the term “electric vehicle” includes any vehicle or transport machine that is driven at least in part by electricity (e.g., all-electric vehicles, hybrid vehicles, etc.). In this disclosure, relative terms such as “about,” “substantially,” etc. is used to indicate a possible variation of ±10% in the stated or implied value.

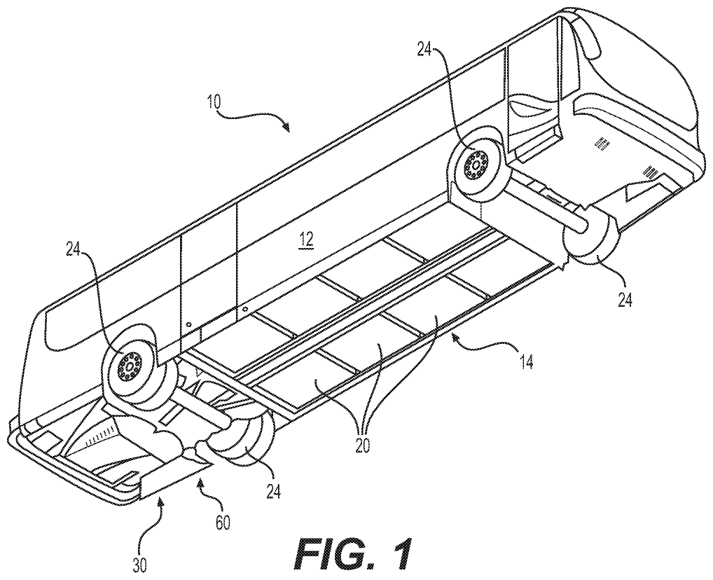

FIG. 1 illustrates an electric vehicle 10 (EV10) in the form of a bus. EV 10 may include a body 12 enclosing a space for passengers. In some embodiments, some (or substantially all) parts of body 12 may be fabricated using one or more composite materials to reduce the weight of EV 10. Without limitation, body 12 of EV 10 may have any size, shape, and configuration. In some embodiments, EV 10 may be a low-floor electric bus. As is known in the art, in a low-floor bus, there are no stairs at the front and/or the back doors of the bus. In such a bus, the floor is positioned close to the road surface to ease entry and exit into the bus. In some embodiments, the floor height of the low-floor bus may be about 12-16 inches from the road surface.

Among many other systems, EV 10 may include a powertrain 30 that propels the vehicle along a road surface, and a suspension 60 that connects the vehicle body 12 to its wheels 24 while allowing relative motion between them. As would be known to a person of ordinary skill in the art, suspension 60 includes components (such as, for example, shock absorbers or air bags, springs, etc.) and linkages that connect the body of EV 10 to its wheels 24, and powertrain 30 includes electric motor(s) that generate power and a transmission that transmits the power to the wheels 24. Batteries 14 may store electrical energy to power the electric motor(s). Although not a requirement, in some embodiments, as illustrated in FIG. 1, batteries 14 may be configured as a plurality of battery packs 20 positioned under the floor of EV 10. Batteries 14 may have any chemistry (e.g., lithium titanate oxide (LTO), nickel metal cobalt oxide (NMC), etc.) and construction. Some of the possible battery chemistries and arrangements in EV 10 are described in commonly assigned U.S. Pat. No. 8,453,773, which is incorporated herein by reference in its entirety.

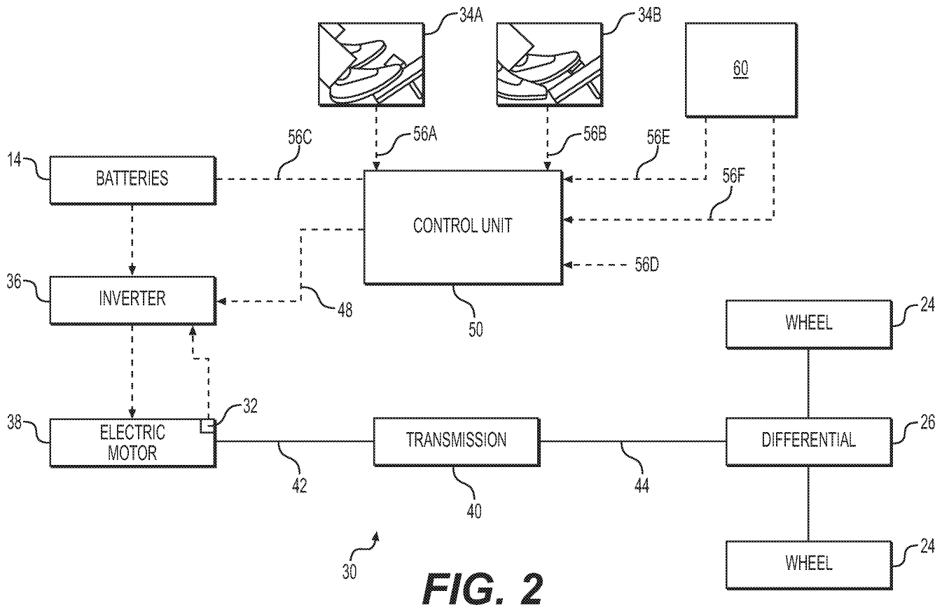

FIG. 2 is a schematic illustration of an exemplary powertrain 30 of EV 10. Powertrain 30 includes an electric motor 38 that generates power, and a transmission 40 that transmits the power to the drive wheels 24 of EV 10. The drive wheels 24 may be one set of wheels (e.g., front wheels or rear wheels, etc.) of EV 10, or all the wheels (e.g., front wheels and rear wheels) of EV 10. Although FIG. 2 illustrates one electric motor 38 providing power to one set of drive wheels 24 (e.g., rear), this is only exemplary. In some embodiments, a separate motor may be provided to power each drive wheel separately. In some embodiments, electric motor 38 may be a permanent magnet synchronous motor (AC motor) that operates using power from batteries 14. In some embodiments, high voltage DC power from batteries 14 may be converted into 3-phase AC power using an inverter 36 and directed to electric motor 38. Motor 38 drives the input shaft 42 to transmission 40. An output shaft 44 from transmission 40 rotates the drive wheels 24 through a differential 26. In general, the torque output of electric motor 38 is proportional to the magnitude of the current directed to electric motor 38 from inverter 36. Although electric motor 38 is described as a permanent magnet synchronous motor, other types of motors may also be used in powertrain 30.

Transmission 40 may include a plurality of gears (not shown) with the ability to switch between different gear ratios to convert the rotation speed (and torque) of input shaft 42 to several different speeds (and torques) of output shaft 44. While, in general, any type of transmission 40 with any number of gear ratios may be used in EV 10, in some embodiments, transmission 40 may be an automatic transmission that provides two gear ratios using a set of planetary gears. As is known in the art, the planetary gears may include sun, ring, and carrier gears, with planetary gears coupled thereto. Transmission 40 may also include a plurality of clutches adapted to selectively couple several of the gears together to change the gear ratio between input shaft 42 and output shaft 44 based on instructions from a control unit 50. Additionally, as is known in the art, transmission 40 may include other devices such as, for example, synchronizers that equalize the speed difference between input and output shafts 42, 44.

Control unit 50 may be configured to control various operations of powertrain 30. Control unit 50 may be an electronic device dedicated to controlling the operations of powertrain 30, or it may be part of a larger controller that controls several operations (for example, HVAC control, door opening/closing, kneeling, etc.) of EV 10. As is known in the art, control unit 50 may include a collection of several controllers and other components (e.g., mechanical, electrical, integrated circuit and safety devices (for example, computational units, A/D converters, memories, switches, actuators, fuses, etc.) that function collectively to control the operation of powertrain 30.

Control unit 50 may control the operation of powertrain 30 based on several inputs 56A, 56B, 56C, 56D, 56E, 56F, etc. These inputs may include signals indicative of operation of EV 10. In some embodiments, an input 56A to control unit 50 may include a signal indicative of the position of the accelerator pedal 34A of EV 10. During operation, the driver of EV 10 presses (or steps on) an accelerator pedal 34A to accelerate EV 10 (e.g., to climb a hill, increase speed, etc.). Similarly, the driver presses on a brake pedal 34B to slow down EV 10. Position sensors (not shown) operatively coupled to accelerator pedal 34A and brake pedal 34B convert the position of these pedals to voltage signals. These voltage signals are directed as inputs 56A and 56B into control unit 50. Input 56A (and input 56B in some cases) is indicative of the requested torque from the driver. For example, when the driver needs more torque, input 56A increases. And, when the driver needs less torque, input 56A decreases and/or input 56B increases.

Control unit 50 may also receive an input 56C indicative of the current state of charge (SOC) of batteries 14, and an input 56D indicative of the current environmental conditions (e.g., signal from a temperature sensor, ice/freezing sensor, etc.). As will be described in more detail later, control unit 50 may also receive inputs 56E and 56F from supporting systems of EV 10 (e.g., suspension 60). And, based on these inputs 56A-56F, control unit 50 may send a signal 48 to inverter 36. Signal 48 may be indicative of the magnitude of the electric current to be directed from inverter 36 to electric motor 38. For example, when the magnitude of signal 48 is higher, more current is directed from inverter 36 to motor 38 to increase its output torque. Since, the torque produced by motor 38 is proportional to the current directed to it, signal 48 is also indicative of the torque output by motor 38.

As is known in the art, inverter 36 may be an electronic device (or circuitry) adapted to convert direct current (DC) from batteries 14 to alternating current (AC). In response to signal 48 from control unit 50, inverter 36 may activate IGBTs (insulated-gate bipolar transistors) or other switches (of inverter 36) to convert the direct current (DC) from batteries 14 to simulated AC current for electric motor 38. Inverter 36 may select the voltage and the frequency of the AC current to produce the desired torque output (or acceleration). Motor 38 may include one or more sensors 32 (speed sensor, torque sensor, etc.) configured to provide a signal indicative of the actual torque output by motor 38 to inverter 36. Based on this feedback from sensor 32, inverter 36 may modify (increase, decrease, etc.) the current directed to motor 38 to produce the desired torque output. Although FIG. 2 illustrates sensor 32 as providing input to inverter 36, in some embodiments, the input from sensor 32 may additionally or alternatively be directed to control unit 50. In such embodiments, control unit 50 may modify signal 48 to inverter 36 based on the feedback from sensor 32. Additionally or alternatively, in some embodiments, inverter 36 may include a sensor (current sensor, etc.) that measures the current directed to motor 38, and use the detected current as a feedback signal.

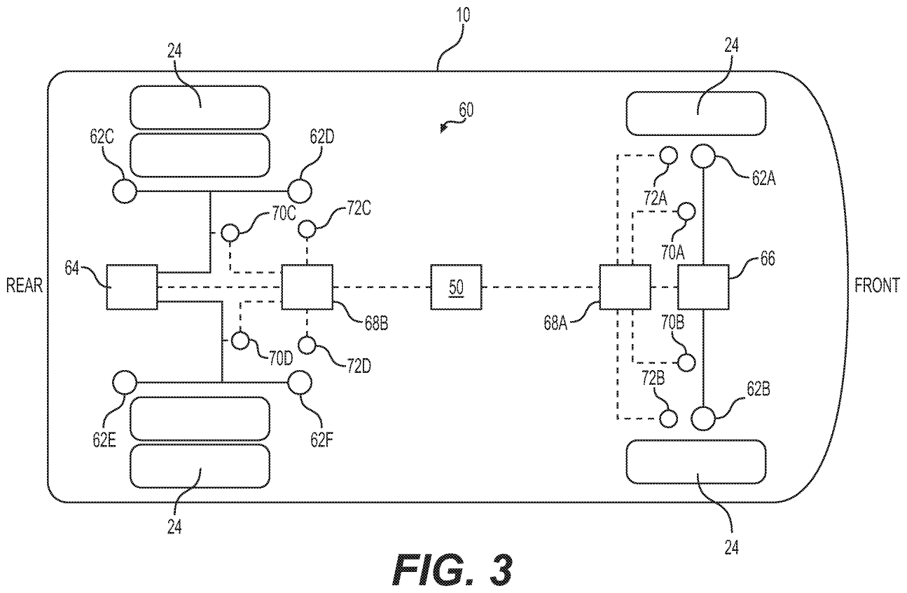

FIG. 3 is a schematic illustration of suspension 60 of EV 10 in an exemplary embodiment. It should be noted that, for clarity, only the pneumatic portion of suspension 60 is illustrated in FIG. 3. Suspension 60 includes a plurality of adjustable damping devices, such as air-springs 62A-62F (or air bags), configured to absorb a portion of the road forces. As would be known to a person skilled in the art, each air-spring includes a volume of a fluid (air, gas, etc.) confined within a container (a tough rubber or plastic enclosure, etc.). In some embodiments, an air-spring may be positioned in each corner of EV 10 (e.g., an air-spring proximate each wheel). In some embodiments, as illustrated in FIG. 3, two air-springs are positioned proximate each rear wheel, and one air-spring is positioned proximate each front wheel. For example, with reference to FIG. 3, air-springs 62A and 62B are positioned proximate the front wheels 24, and a pair of air-springs 62C, 62D are positioned proximate the rear wheels 24 on one side (curb-side) and a pair of air-springs 62E, 62F are positioned proximate the rear wheels 24 on the opposite side (street-side). The air-springs 62C-62F in the rear are fluidly connected to a rear height manifold 64 (or valve), and the air-springs 62A-62B in the front are fluidly connected to a front height manifold 66. These manifolds 64, 66 direct a compressed fluid (e.g., compressed air) from a compressed fluid supply (not shown) of EV 10 to air-springs 62A-62F.

A rear height controller 68B is operatively coupled to the rear height manifold 64, and a front height controller 68A is operatively coupled to the front height manifold 66. The front and rear height controllers 68A, 68B are coupled to control unit 50 (or another controller operatively connected to control unit 50). Based on input from control unit 50, the front and rear height controllers 68A, 68B selectively direct compressed fluid (e.g., high pressure air or gas) into the front and rear air-springs 62A-62B and 62C-62F to raise or lower the front and/or rear of EV 10 with respect to the road surface. Suspension 60 includes sensors configured to detect parameters indicative of the performance of suspension 60. These sensors may include, among others, pressure sensors 70A-70D and position sensors 72A-72D.

Pressure sensors 70A-70D may be configured to detect the pressure of each air-spring. In some embodiments, as illustrated in FIG. 3, the pressure sensors may be configured to detect the pressure of the air-springs in each corner of EV 10. For example, with reference to FIG. 3, pressure sensor 70A may be configured to detect the pressure of air-spring 62A, pressure sensor 70B may be configured to detect the pressure of air-spring 62B, pressure sensor 70C may be configured to detect an average pressure of air-springs 62C and 62D, and pressure sensor 70D may be configured to detect an average pressure of air-springs 62E and 62F. Any type of sensor (e.g., strain-gauge based, capacitive, electromagnetic, piezoelectric, optical, potentiometric, micro-electro-mechanical (MEMS) type system etc.) suitable for measuring or estimating the pressure of the fluid in an air-spring may be used as a pressure sensor. It should be noted that, in some embodiments (as illustrated in FIG. 3), a pressure sensor may determine or estimate the pressure in an air-spring based on the pressure in a conduit that directs fluid to the air-spring. The pressure sensors 70A, 70B in the front may be coupled to front height controller 68A, and the pressure sensors 70C, 70D in the rear may be coupled to rear height controller 68B. The front and rear height controllers 68A, 68B may send data related to the output of pressure sensors 70A-70D to control unit 50 as input 56E (see FIG. 2).

Position sensors 72A-72D are configured to detect the position (relative or absolute position) of each corner of EV 10 with respect to a datum or a reference plane (e.g., road surface, floor of bus, etc.). For example, the output signal from each position sensor 72-72D may be indicative of the height of the respective corner of EV 10 from the road surface. In some embodiments, position sensors 72A-72D detect suspension travel as a relative distance from an arbitrary “zero” position. That is, the signal from a position sensor may be indicative of height above the arbitrary “zero” position. The distance from the sensor's mounting point on the suspension to the road is assumed to be constant and may be used to calibrate this “zero” position. Any suitable sensor (e.g., capacitive sensor, capacitive displacement sensor, eddy-current sensor, ultrasonic sensor, grating sensor, rotary hall-effect sensor, inductive non-contact position sensor, piezo-electric transducer, proximity sensor, linear variable displacement transducer (LVDT), magnetostrictive sensor, etc.) may be used as a position sensor. In some embodiments, position sensors 72A-72D may be used to determine the position or state of suspension components, such as air-spring height, damper position, axle tilt/twist/roll, etc. The position sensors 72A, 72B in the front may be coupled to front height controller 68A, and the position sensors 72C, 72D in the rear may be coupled to rear height controller 68B. The front and rear height controller 68A, 68B may send data related to the output of position sensors 72A-72D to control unit 50 as input 56F (see FIG. 2). In some embodiments, control unit 50 may use input 56F to level the floor of EV 10 (e.g., bus floor) to the road surface. For example, the compressed fluid directed into the air-springs in each corner of EV 10 may be controlled to level the floor of EV 10.

The output from each pressure sensor 70A-70D may be indicative of the passenger/cargo weight (e.g., based on number of passengers, cargo load, etc.) in the respective corner of EV 10. And, the difference between the outputs of pressure sensor 70A-70D may be indicative of the distribution of passengers/cargo in EV 10. For example, if there are more passengers in the rear as compared to the front of EV 10, pressure sensors 70C, 70D may indicate a higher pressure as compared to pressure sensors 70A, 70B. Thus, input 56B may be indicative of the current weight/number of cargo/passengers and their distribution in EV 10. In some embodiments, as will be discussed later, control unit 50 may use inputs 56E and 56F (i.e., data from pressure and position sensors) to determine the weight of each corner of EV 10 using calibration curves.

As explained previously, control unit 50 sends a signal 48 to inverter 36 in response to input 56A (and/or input 56B) that is indicative of the torque desired from the driver of EV 10. Control unit 50 may include functions (e.g., equations, curves, tables, etc.) to map accelerator pedal (and/or brake pedal) input to torque demanded. For instance, based on the accelerator pedal input and the preprogrammed chart or map in control unit 50, control unit 50 determines the value of signal 48 (e.g., magnitude of current) to be directed to inverter. In some embodiments, control unit 50 may modify signal 48 based on the “drive mode” (e.g., “Eco” mode, “Sport” mode, etc.) selected by the driver. In embodiments of the current disclosure, control unit 50 uses the inputs 56E, 56F from suspension 60 (and/or other vehicle supporting systems) to modify signal 48 and improve the performance of the vehicle powertrain 30. For example, control unit 50 uses the vehicle weight information derived from inputs 56E and 56F of suspension 60 to modify the acceleration and braking torque to make the vehicle acceleration and braking performance uniform irrespective of passenger/cargo load. For example, based on vehicle weight and/or weight distribution, control unit 50 modifies the driver's torque request so that acceleration is normalized relative to vehicle weight. If more passengers or cargo are loaded in EV 10, the acceleration or EV 10 would be maintained by applying a higher torque when acceleration is requested.

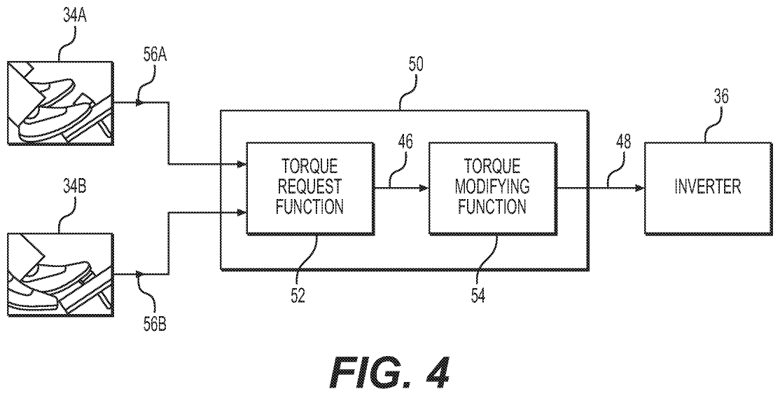

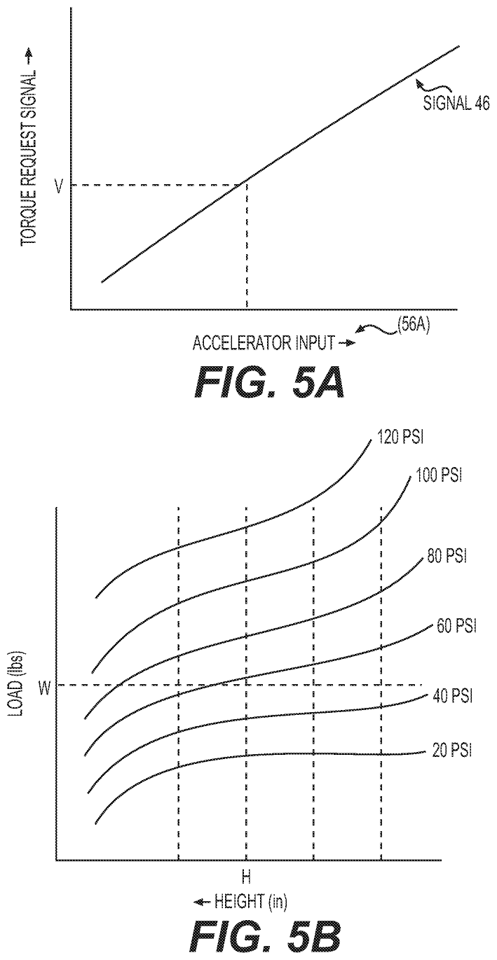

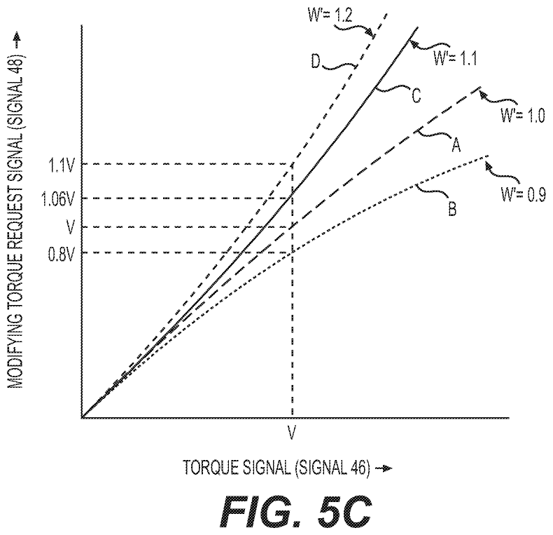

FIG. 4 is a schematic illustration of an embodiment of control unit 50 that directs a signal 48 to inverter 36 based on the inputs to control unit 50. Among other systems, control unit 50 may include a torque request function 52 and an torque modifying function 54. Torque request and torque modifying functions 52, 54 may include electronic components (or systems) and/or algorithms configured to produce signal 48. Torque request function 52 may be an algorithm or module that converts input 56A indicative of the position of accelerator pedal 34A (and/or input 56B indicative of the position of brake pedal 34B) into a torque request signal 46. As explained previously, inputs 56A and 56B may include voltage signals from position sensors (e.g., optical encoders) operatively coupled to the accelerator and brake pedals 34A, 34B, respectively. Torque request function 52 may translate the input signal 56A (and/or signal 56B) into a torque request signal 46. In general, torque request function 52 may include a map (table, graph, chart, etc.), an empirical relation, or an equation that converts the voltage signal from the accelerator pedal 34A to the torque request signal 46. FIG. 5A illustrates an exemplary curve that may be used to convert input 56A (indicative of accelerator pedal 34A position) to torque request signal 46. For example, with reference to FIG. 5A, corresponding to a particular value of input 56A, torque request function 52 may output a torque request signal 46 having a magnitude “V.” It should be noted that the linear curve illustrated in FIG. 5A is only exemplary, and in general, the curve may have any form (curved, piece wise linear, etc.). Exemplary control methodologies (e.g., electronic-throttle-by-wire control systems) that may be implemented in torque request function 52 are described in “Implementation of Electronic Throttle-by-Wire for a Hybrid Electric Vehicle using National Instruments' Compact RIO and LabVIEW Real-Time,” 5th International Conference on Intelligent and Advanced Systems (ICIAS), June 2014. As illustrated in FIG. 4, torque request signal 46 output by the torque request function 52 is directed to the torque modifying function 54.

Torque modifying function 54 modifies the torque request signal 46 based on the current weight of EV 10 (based on input 56E from suspension 60) and outputs signal 48 to inverter 36. Control unit 50 may determine the current weight of EV 10 from inputs 56E and/or 56F in any manner. For example, in some embodiments, the air-springs used in suspension 60 may be calibrated to correlate its output signal to a weight value. In some embodiments, calibration curves corresponding to the air-springs may be provided by the air-spring manufacturer. In some embodiments, experiments may be carried to correlate the outputs of pressure sensors 70A-70D to vehicle weight. FIG. 5B illustrates an exemplary calibration curve that may be used by control unit 50 to correlate inputs 56E, 56F to vehicle weight. Based on the position and pressure sensor outputs from each corner of EV 10, control unit 50 may determine the weight of the corresponding corner of EV 10 using the exemplary calibration curve of FIG. 5B. For example, if the output of the position sensor in one corner of EV 10 (e.g., curb-side front) indicates a height of “H₁,” and the pressure sensor from that corner indicates a pressure of 60 psi (for example), control unit 50 may determine that the weight of that corner as “W₁.” Based on the determined weights of each corner (W₁, W₂, W₃, W₄), control unit 50 may determine the total weight W of EV 10 as a function of the corner weights W₁, W₂, W₃, and W₄ (for e.g., W=W₁+W₂+W₃+W₄).

Torque modifying function 54 may include a map (table, graph, etc.), an empirical relation, or an equation that converts the torque request signal 46 from torque request function 52 to inverter signal 48 based on the determined weight of EV 10. FIG. 5C illustrates a plot of exemplary curves that may be used to convert the torque request signal 46 to inverter signal 48 based on a normalized weight W′ of EV 10. The normalized weight W′ is the ratio of the current weight of EV 10 (determined, for example, based on FIG. 5B) to an expected weight of EV 10 (e.g., weight of EV 10 with a standard/expected load or number of passengers). For example, with reference to FIG. 5C, curve A (with W′=1) indicates that the current weight of EV 10 is approximately equal to the expected weight, and curve C (with W′=1.1) indicates that the current weight is approximately 10% greater than the expected weight, etc. If the current normalized weight W′ of EV is 1.1 (i.e., W′=1.1), torque modifying function 54 may use curve C to modify the input signal (torque request signal 46), and if W′=1.2, curve D may be used to modify signal 46, etc. For example, with reference to FIG. 5C, if the torque request signal 46 has a magnitude of “V” and the current normalized weight W′ of EV 10 is 0.9, the value of signal 48 output by torque modifying function 54 may be 0.8 times “V” (i.e., 0.8×torque request signal 46), etc. It should be noted that, the configuration of the curves shown in FIG. 5C are only exemplary. In general, these curves may have any form. Signal 48 output by control unit 50 is directed to inverter 36.

In some embodiments, curves A-D of FIG. 5C may be selected based on factors such as, driver feel, passenger comfort, etc. For example, experiments or prior experience may indicate that when the weight of EV 10 is greater than its normal or expected weight by 10% (i.e., when W′=1.1), the current input to inverter 36 should be increased by about 6% (e.g., signal 48=1.06×“V”) to produce the acceleration (and torque) that is expected by the driver at that accelerator pedal position. Producing a lower acceleration than what is expected by the driver may negatively affect driver feel and passenger comfort (e.g., response of EV may be sluggish, etc.). Similarly, when the weight of EV 10 is lower than expected, reducing the signal to inverter 32 for the same accelerator pedal position will allow powertrain 30 to deliver the torque and acceleration expected by the driver. Thus, monitoring the weight of EV 10 in a real-time manner based on the data from suspension 60, and modifying the signal to inverter 36 based on the monitored weight increases driver feel and passenger comfort. Control unit 50 may also modify the signal 48 to inverter in response to the brake pedal position (input 56B) based on the current weight of EV 10 in a similar manner. For example, torque modifying function 54 may modify the signal 48 to inverter 36 corresponding to the position of brake pedal 34B (i.e., input 56B) based on the current weight of EV 10.

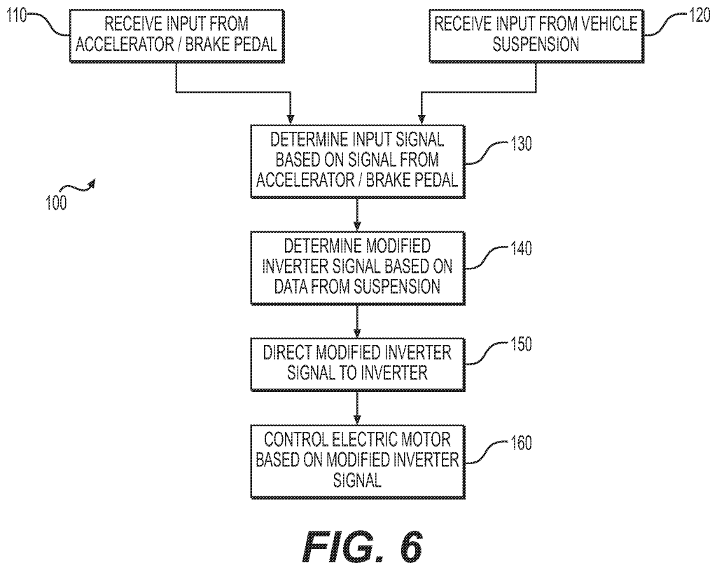

FIG. 6 is a flow chart that illustrates an exemplary method 100 for adaptively controlling the powertrain 30 of EV 10. Data from the accelerator pedal 34A and data from the air-springs 62A-62F of suspension 60 are directed into the control unit 50 (steps 110, 120). The control unit 50 determines the torque request signal 46 (for e.g., from a preprogrammed map) based upon the data from the accelerator pedal 34A (step 130). The control unit 50 then modifies the torque request signal 46 based on data from the suspension 60 to determine the inverter signal 48 (step 140). In some embodiments, in step 140, the control unit 50 determines the weight of EV 10 using the data from suspension 60, and uses the determined weight to modify the torque request signal (e.g., using a preprogrammed map). The modified torque request signal is then directed to inverter 36 as inverter signal 48 (step 150). And, electric motor 32 of powertrain 30 is controlled based on the received inverter signal (step 160).

Although only the use of suspension data (e.g., inputs 56E, 56F) to modify the acceleration and braking torque of EV 10 is described above, control unit 50 may also use the data from suspension 60 (e.g., inputs 56E, 56F) for other purposes. For example, control unit 50 may use the data from pressure sensors 70A-70D (i.e., input 56E) to determine the weight distribution in EV 10 and maintain corner weight balance. For example, if control unit 50 determines that the weight of EV 10 is greater in the front than the rear (or greater in one corner of EV 10) based on input 56E and/or input 56F, control unit 50 may direct different amounts of air to the different air-springs 62A-62F to counteract the weight imbalance and modify damping performance to maintain suspension feel. Control unit 50 may also use the inputs 56E, 56F from suspension 60 to estimate vehicle ridership (passenger counting), locate road features (e.g., potholes, speed bumps, road grade etc. based on, for example, sudden changes in weight), estimate center of gravity of EV 10, modify vehicle aerodynamics, change ground clearance, etc.

While principles of the present disclosure are described herein with reference to controlling the torque output of an electric vehicle motor based on pressure data from the vehicle suspension, it should be understood that the disclosure is not limited thereto. Rather, the systems and methods described herein may be employed to adaptively control the powertrain of any vehicle (i.e., vehicle having any type of power source (such as, for example, internal combustion (IC) engine, etc.) using data from the suspension system of the vehicle. For example, in an application on a vehicle powered by an IC engine, based on the data related to the vehicle weight from the suspension system, the engine controller modifies the torque request from the accelerator/brake pedal, and controls the IC engine (or the power source) to produce the modified torque request.

In the exemplary EV described above, an inverter 36 is used to convert DC current from batteries 14 to AC current for electric motor 38. Therefore, control unit 50 directs signal 48 to the inverter 36 to control the torque produced by motor 38. However, the use of an inverter is not a requirement (e.g., if motor 38 is a DC motor, in application where AC current from the grid is directed to motor 38, etc.). In such embodiments, a power controller of control unit 50 may directly control the motor using the determined signal 48. Additionally, those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description. For example, while certain features have been described in connection with various embodiments, it is to be understood that any feature described in conjunction with any embodiment disclosed herein may be used with any other embodiment disclosed herein.

We claim:

1. An electric vehicle, comprising:
an electric motor configured to provide traction for the electric vehicle;
a suspension system;
an inverter operatively coupled to the electric motor, the inverter being configured to control the electric motor based on an inverter signal; and
a control system configured to:
receive operator input data indicative a desired torque;
receive data from the suspension system;
determine the inverter signal based on (a) the operator input data and (b) the data from the suspension system; and
direct the determined inverter signal to the inverter.

2. The electric vehicle of claim 1, wherein the control system is configured to determine a weight of the electric vehicle based on the received data from the suspension system.

3. The electric vehicle of claim 1, wherein the control system is configured to determine a weight distribution in the electric vehicle based on the received data from the suspension system.

4. The electric vehicle of claim 1, wherein the control system is configured to determine a torque request signal based on the received operator input data, and modify the determined torque request signal based on the received data from the suspension system to produce the inverter signal.

5. The electric vehicle of claim 1, wherein the suspension system includes a plurality of air-springs and a plurality of pressure sensors configured to detect a pressure associated with the plurality of air-springs.

6. The electric vehicle of claim 5, wherein the received data from the suspension system includes data from the plurality of pressure sensors.

7. The electric vehicle of claim 1, wherein the suspension system includes one or more air-springs positioned proximate each corner of the vehicle, and pressure sensors configured to detect the pressure associated with the one or air-springs positioned proximate each corner.

8. The electric vehicle of claim 1, wherein the suspension system includes a plurality of position sensors, wherein the plurality of position sensors are arranged to determine the height of each corner of the electric vehicle above a common datum.

9. The electric vehicle of claim 1, further including an accelerator pedal and a brake pedal, wherein the received operator input data includes data corresponding to a position of one or both of the accelerator pedal and the brake pedal.

10. The electric vehicle of claim 1, wherein the electric vehicle is a bus.

11. An electric vehicle, comprising:
a powertrain configured to provide traction, the powertrain including an power controller operatively coupled to an electric motor, the power controller being configured to control the electric motor based on a received power signal;
an accelerator pedal;
a suspension system including (a) one or more air-springs and (b) one or more pressure sensors configured to detect a pressure in the one or more air-springs; and
a control system configured to:
receive data from the accelerator pedal;
receive data from the one or more pressure sensors of the suspension system;
determine the power signal based on (i) the accelerator pedal data and (ii) the data from the one or more pressure sensors.

12. The electric vehicle of claim 11, wherein the control system is configured to determine a weight of the electric vehicle based on the received data from the one or more pressure sensors.

13. The electric vehicle of claim 11, wherein the control system is configured to determine a weight distribution in the electric vehicle based on the received data from the one or more pressure sensors.

14. The electric vehicle of claim 11, wherein the control system is configured to determine a torque request signal based on the received data from the accelerator pedal, and modify the determined torque request signal based on the received data from the one or more pressure sensors to produce the power signal.

15. The electric vehicle of claim 11, wherein the suspension system includes one or more air-springs positioned proximate each corner of the vehicle, and the one or more pressure sensors are configured to separately detect the pressure in the one or air-springs positioned proximate each corner.

16. The electric vehicle of claim 11, wherein the suspension system further includes a plurality of position sensors, wherein the plurality of pressure sensors are arranged to determine the height of each corner of the electric vehicle above a common datum.

17. A method of operating a vehicle, comprising:
receiving data indicative of a requested torque from an accelerator pedal of the vehicle;
receiving data indicative of vehicle weight from a suspension system of the electric vehicle;
determining a torque request signal based on (a) the received accelerator pedal data and (b) the received data from the suspension system; and
controlling a power source of the vehicle based on the determined torque request signal to produce torque.

18. The method of claim 17, wherein determining the torque request signal includes (i) determining a first signal based on the received data from the accelerator pedal and (ii) modifying the determined first signal based on the received data from the suspension system to produce the torque request signal.

19. The method of claim 17, wherein receiving the data indicative of vehicle weight includes receiving at least pressure data associated with one or more air-springs of the suspension system.

20. The method of claim 17, further including determining the vehicle weight from the received data from the suspension system.
